(19) United States
(12) Patent Application Publication
(10) Pub. No.: US 2015/0008881 A1
(43) Pub. Date: Jan. 8, 2015

(54) VEHICLE CHARGER

(71) Applicant: HON HAI PRECISION INDUSTRY CO., LTD., New Taipei (TW)

(72) Inventor: CHIH-CHUNG WENG, New Taipei (TW)

(21) Appl. No.: 14/324,376

(22) Filed: Jul. 7, 2014

(30) Foreign Application Priority Data
Jul. 8, 2013 (TW) 102124345

(51) Int. Cl. H02J 7/00

(52) U.S. Cl. CPC H02J 7/0054; H02J 7/0047
USPC 320/114

(57) ABSTRACT

A vehicle charger includes a main body, a circuit unit, and a display module. The main body forms a plug portion at one end and an electricity transmission portion at the other end. The circuit unit includes a power supply module, a sensing circuit, a switch module, a charging circuit, and a micro processor electrically coupling the sensing circuit and the display module. The switch module can control the sensing circuit to switch between detection of the power supply module and detection of the charging circuit.

### FIELD

The present disclosure generally relates to a charger, and particularly to a vehicle charger.

### BACKGROUND

Vehicle chargers are configured for charging electrical devices through a vehicle power supply.

### BRIEF DESCRIPTION OF THE DRAWINGS

Implementations of the present technology will now be described, by way of example only, with reference to the attached figures.

FIG. 1 is an isometric view of an embodiment of an assembled vehicle charger.

FIG. 2 is a rear view of the vehicle charger of FIG. 1.

FIG. 3 is a block diagram of the vehicle charger of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

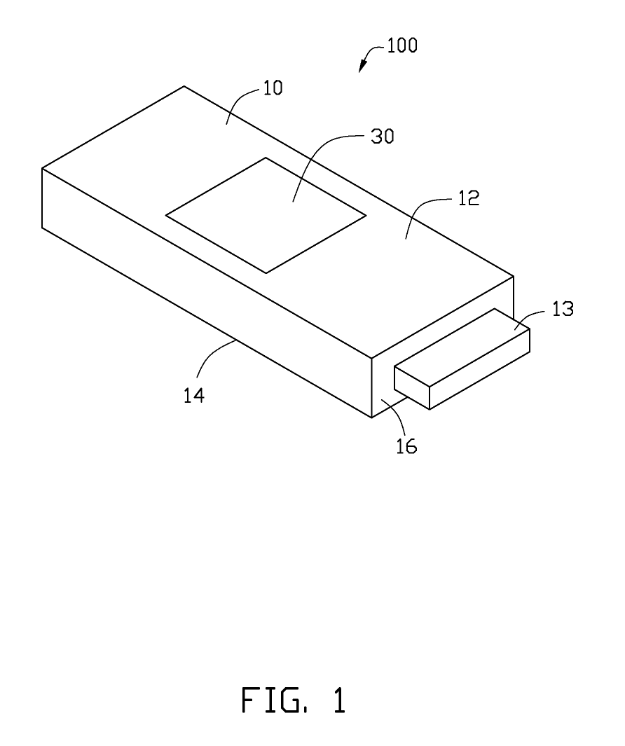

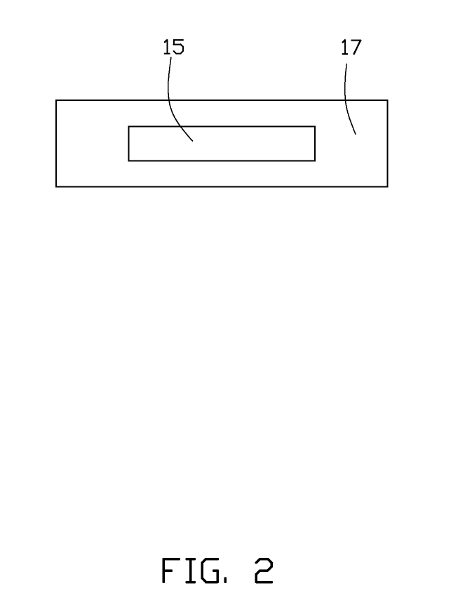

FIGS. 1-3 illustrate an embodiment of a vehicle charger 100 including a main body 10, a display screen 30 assembled on the main body 10, a circuit unit 50 received in the main body 10, and a display unit 70 also received in the main body 10. The display unit 70 can electrically couple the circuit unit 50 and the display screen 30 to allow messages of the circuit unit 50 to be displayed on the display screen 30. In the illustrated embodiment, the vehicle charger 100 can be configured to charge electronic devices, such as mobile phones.

The main body 10 can be substantially rectangular and include a first surface 12, a second surface 14 parallel to the first surface 12, a front end face 16 coupling the first surface 12 and the second surface 14, and a rear end face 17 parallel to the front end face 16. A plug portion 13 can protrude from the front end face 16 and can be configured to be electrically coupled to a power supply. The main body 10 can further form an electricity transmission portion 15 on the rear end face 17. The electricity transmission portion 15 can be configured to be coupled to the electronic devices. The display screen 30 can be assembled on the first surface 12.

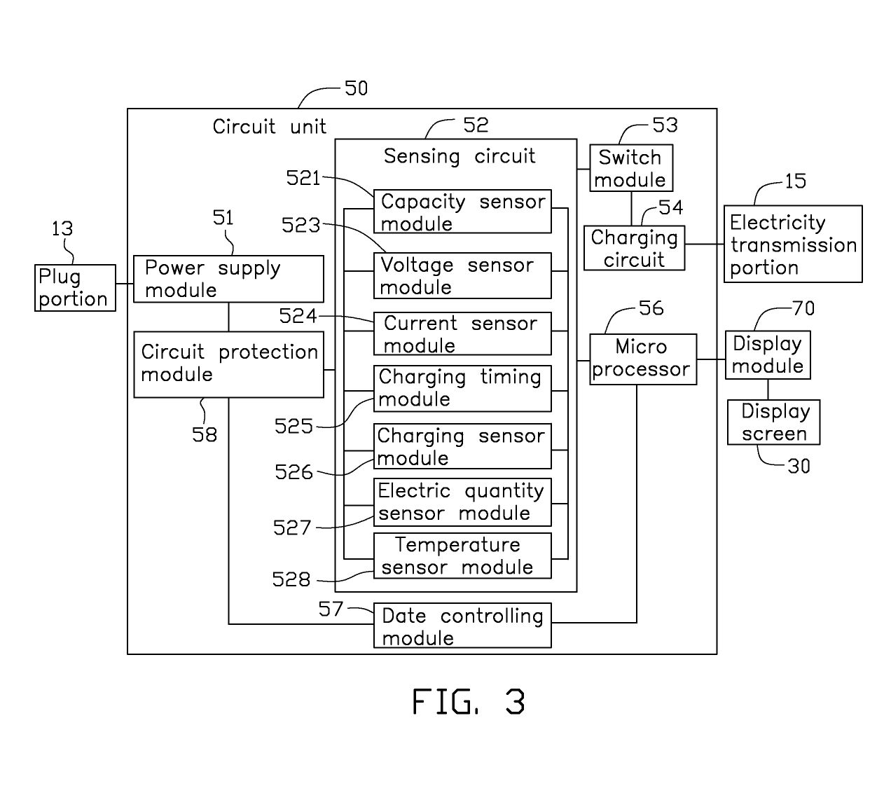

FIG. 3 illustrates the circuit unit 50 including a power supply module 51, a sensing circuit 52, a switch module 53, a charging circuit 54, a micro processor 56, a date controlling module 57, and a circuit protection module 58. The power supply module 51 can be electrically coupled to the plug portion 13 and configured to transmit electric current imported via the plug portion 13. The circuit protection module 58 can be electrically coupled to the power supply module 51 and configured to cut off the power supply module 51 to protect the electronic devices from damage when a car battery is malfunctioning. The sensing circuit 52 can be electrically coupled to the circuit protection module 58, and can include, all in parallel, a capacity sensor module 521, a voltage sensor module 523, a current sensor module 524, a charging timing module 525, a charging sensor module 526, an electric quantity sensor module 527, and a temperature sensor module 528. The sensing circuit 52 can read and detect charging signals. The micro processor 56 can be electrically coupled to the sensing circuit 52, and can compare a charging voltage to a predetermined voltage. The charging circuit 54 can be electrically coupled to the electricity transmission portion 15 to charge the electronic devices. The switch module 53 can electrically couple the sensing circuit 52 and the charging circuit 54. The switch module 53 can be configured to switch the sensing circuit 52, in other words, the sensing circuit 52 can be switched to detect the power supply module 51 or switched to detect the charging circuit 54. The date controlling module 57 can electrically couple the power supply module 51 and the micro processor 56 and generate signals as to the date.

The display module 70 can electrically couple the micro processor 56 and the display screen 30 and is configured to receive and transmit the charging signals and the signals as to the date to the display screen 30. In the illustrated embodiment, the display screen 30 can be a liquid crystal display screen or an organic light emitting diode display screen.

In operation, the plug portion 13 can be inserted into a cigarette lighter of a car. The capacity sensor module 521, the voltage sensor module 523, and the electric quantity sensor module 527 can detect a capacity percentage, a charging voltage, and a grid number of the capacitor. The micro processor 56 can process and transmit the charging signals to the display module 70 and the display screen 30. The micro processor 56 can further compare the levels of a charging voltage to a predetermined voltage, and then the micro processor 56 can control the circuit protection module 58 to cut off the power supply module 51 when the charging voltage is not equal to the predetermined voltage.

In the illustrated embodiment, when a standard voltage of a car is 12 volts, the predetermined voltage can be in a range from 13.3 to 14.8 volts. In other embodiments, when the standard voltage of the car is 24 volts, the predetermined voltage can be in a range from 23.8 to 26.5 volts, as long as the electronic devices can be charged via the vehicle charger 100 in the predetermined voltage. The date controlling module 57 generates and transmits a signal as to the date to the display screen 30 via the micro processor 56.

When an electronic device is inserted into the electricity transmission portion 15, the switch module 53 switches the sensing module 52 to detect the charging circuit 54. The capacity sensor module 521, the voltage sensor module 523, and the electric quantity sensor module 527 can read and detect the capacity percentage, a charging voltage, and a grid number of capacity. The current sensor module 524, the charging timing module 525, the charging sensor module 526, and the temperature sensor module 528 can read and detect a charging current, a charging time, a charging configuration, and a temperature of a battery of the electronic device. The micro processor 56 can receive and transmit the charging signal to the display screen 30 via the display module 70.

In other embodiments, the voltage sensor module 523, the current sensor module 524, the charging timing module 525, the charging sensor module 526, the temperature sensor module 528, and the date controlling module 57 can be omitted. A user can decide if the electronic device needs to be charged through the capacity percentage signal detected via the capacity sensor module 521 and the charging signal of the grid number of capacitor detected via the electric quantity sensor module 527, and the electronic device can be powered off when the capacity percentage is found to be 100 percent.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. A vehicle charger comprising:
a main body;
a plug portion protruding from the main body and configured to be electrically coupled a power supply;
an electricity transmission portion formed on the main body and configured to be coupled to electronic devices;
an circuit unit received in the main body comprising:
a power supply module electrically coupled to the plug portion;
a sensing circuit electrically coupled to the power supply module;
a switch module electrically coupled to the sensing circuit;
a charging circuit electrically coupling the switch module to the electricity transmission portion , wherein the switch module controls the sensing circuit to switch between detection of the power supply module and detection of the charging circuit ;
a microprocessor electrically coupled to the sensing circuit;
a display module received in the main body and electrically coupled to the microprocessor;
a display screen coupled to the main body and electrically coupled to the display module.

2. The vehicle charger of claim 1, wherein the sensing circuit comprises a capacity sensor module and a voltage sensor module parallel to the capacity sensor module, the capacity sensor module is configured to read and detect charging signals of capacity percentage, and the voltage sensor module is configured to read and detect charging signals of charging voltage.

3. The vehicle charger of claim 1, wherein the sensing circuit further comprises a current sensor module parallel to the capacity sensor module and configured to read and detect charging signals of charging current.

4. The vehicle charger of claim 3, wherein the sensing circuit further comprises a charging timing module parallel to the capacity sensor module and configured to read and detect charging signals of charging time.

5. The vehicle charger of claim 3, wherein the sensing circuit further comprises a charging sensor module parallel to the capacity sensor module and configured to read and detect charging signals of charging configuration.

6. The vehicle charger of claim 3, wherein the sensing circuit further comprises an electric quantity sensor module parallel to the capacity sensor module and configured to read and detect charging signals of grid numbers of capacitor.

7. The vehicle charger of claim 3, wherein the sensing circuit further comprises a temperature sensor module parallel to the capacity sensor module and configured to read and detect charging signals of temperature.

8. The vehicle charger of claim 1, wherein the circuit unit further comprise a date controlling module electrically coupling the power supply module and the micro processor module, the date controlling module is configured to generate signals as to the date.

9. The vehicle charger of claim 1, wherein the main body comprises a front end face and a rear end face opposite to the front end face, the plug portion protrudes from the front end face, and the electricity transmission portion is formed on the rear end face.

10. The vehicle charger of claim 1, wherein the circuit unit further comprises a circuit protection module electrically coupling the power supply module and the sensing circuit and configured to cut off the power supply when a charging voltage is not equal to a predetermined voltage.
